(19) United States
(12) Patent Application Publication
(10) Pub. No.: US 2008/0092322 A1
(43) Pub. Date: Apr. 24, 2008

(54) Pool cleaning device

(76) Inventors: Roy Michael Halle, Auburn (AU); Basil Van Rooyen, St. Ives (AU)

Correspondence Address: STETINA BRUNDA GARRED & BRUCKER, 75 ENTERPRISE, SUITE 250, ALISO VIEJO, CA, 92656, US

(21) Appl. No.: 11/975,197

(22) Filed: Oct. 18, 2007

Related U.S. Application Data
(63) Continuation-in-part of application No. 11/884,524.

(30) Foreign Application Priority Data
Oct. 18, 2006 (AU) 2006905783

(51) Int. Cl. A47L 5/38; B08B 5/04

(52) U.S. Cl. 15/301; 134/21

(57) ABSTRACT

An apparatus for inducing variable randomized patterns of traversing at least a floor of a swimming pool by a suction cleaner device; said apparatus including a water flow driven mechanism interposed between a suction pump inlet in a wall of said swimming pool and said suction cleaning device; said apparatus further including a suction hose and an angled connector attached to said suction hose; said angled connector rotatably connected to a swivelling outlet port of said suction cleaning device; said apparatus inducing substantially continuous axial rotation of said suction hose and said angled connector whereby rotating the hose and angled connector alters the geometry of the propulsion force of the pool cleaner thus steering the pool cleaner all over the pool.

### CROSS-REFERENCE TO RELATED APPLICATIONS

The present application is a Continuation-In-Part of U.S. application Ser. No. 11/884,524 entitled STEERING ADAPTOR FOR SUCTION POOL CLEANER which claims priority to Australian Provisional Patent Application No. 2006905783 entitled POOL CLEANING DEVICE which was filed on Oct. 18, 2006. The entire contents of both applications are incorporated herein by reference.

### STATEMENT RE: FEDERALLY SPONSORED RESEARCH/DEVELOPMENT

Not Applicable

### BACKGROUND

### Pool Cleaning Device

The present invention relates to swimming pool cleaning equipment and, more particularly, to drive systems for automated pool cleaning devices intended to traverse the entire wall and floor area of the pool.

Existing suction cleaners are prone to traversing only a portion of the area in a repetitive pattern. They can also become stuck particularly in corners or on steps.

It is an object of the present invention to address or at least ameliorate some of the above disadvantages.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### BRIEF SUMMARY DESCRIPTION OF INVENTION

Accordingly, in a first broad form of the invention, there is provided an apparatus for inducing variable randomized patterns of traversing at least a floor of a swimming pool by a suction cleaner device; said apparatus including a water flow driven mechanism interposed between a suction pump inlet in a wall of said swimming pool and said suction cleaning device; said apparatus further including a suction hose and an angled connector attached to said suction hose; said angled connector rotatably connected to a swivelling outlet port of said suction cleaning device; said apparatus inducing substantially continuous axial rotation of said suction hose and said angled connector whereby rotating the hose and said angled connector alters the geometry of the propulsion force of the pool cleaner thus steering the pool cleaner all over the pool.

Preferably, said axial rotation is continuous and uni-directional.

Preferably, said axial rotation is alternating; said rotation comprising at least a portion of a revolution in a first direction followed by at least a portion of a revolution in a second opposite direction.

Preferably, said angled connector is arranged such that the axis of an inlet end of said connector and the axis of an outlet end of said connector intersect to form a supplementary angle between said inlet axis and said outlet axis; said supplementary angle having a value in the range of 15° to 60°.

Preferably, said water flow driven mechanism is installed coaxially between an outlet end of said suction hose and said suction pump inlet; said mechanism provided with an inlet pipe connected to said outlet end of said hose; said mechanism further provided with an outlet pipe connected to said suction pump inlet.

Preferably, said outlet pipe is connected to a non-rotating first chamber of said mechanism; and wherein a rotating output disc is mounted to said non-rotating first chamber; said non-rotating first chamber housing a turbine paddle wheel rotationally reactive to said water flow.

Preferably, an output shaft of said turbine paddle wheel is connected to a reduction gear train; said reduction gear train adapted to rotate said inlet pipe of said water flow driven mechanism.

Preferably, said inlet pipe is concentrically mounted to a rotating output disc; said rotating output disc provided with an arrangement of gear teeth meshing with an output spur gear of said reduction gear train.

Preferably, said arrangement of gear teeth comprises a ring gear incorporated in said rotating output disc; said ring gear concentric with said disc and said inlet pipe.

Preferably, said ring gear is an external ring gear around the periphery of said rotating output disc.

Preferably, said ring gear is an internal ring gear proximate said periphery of said rotating output disc.

Preferably, a shaft of said output spur gear is retained within a tubular member; said output spur gear shaft provided with a ball-drive end at an end of said shaft distal from said output spur gear; said ball-drive end provided with facets adapted to engage with surfaces within a socket end of said tubular member; said tubular member rotationally mounted between an upper bearing and a lower bearing.

Preferably, said tubular member acts as a shaft of a gear wheel; said reduction gear train acting on said gear wheel to rotate said tubular member; rotation of said tubular member transferred to said output spur gear shaft through said socket and said ball-drive end.

Preferably, said output spur gear is provided with a projecting axle portion; said axle portion supporting a free rotating roller mounted adjacent to and coaxial with said output spur gear.

Preferably, said output spur gear is provided with a projecting tapered spike; said spike coaxial with said output spur gear.

Preferably, said arrangement of gear teeth comprises a looped combination of outward facing teeth and inward facing teeth; said teeth arranged along outside and inside facing surfaces of a spine concentric with the periphery of said rotating output disc; said spine having a gap defined by first and second ends of said spine; said outward facing teeth and said inward facing teeth looping around said first and second ends to form a continuous toothed path.

Preferably, said arrangement of gear teeth comprises a looped combination of outward facing teeth and inward facing teeth; said teeth offset from a spine concentric with the periphery of said rotating output disc; said spine having a gap defined by first and second ends of said spine; said outward facing teeth and said inward facing teeth looping around said ends to form a continuous toothed path.

Preferably, a continuous guide surface is offset from said continuous toothed path; said continuous guide surface comprising outward facing and inward facing guide surfaces looping around said first and second ends to form said continuous guide surface, and wherein said output spur gear is maintained in meshing relationship with said continuous toothed path by contact of said roller with said continuous guide surface.

Preferably, said arrangement of gear teeth comprises a looped combination of outward facing teeth and inward facing teeth forming a continuous looped path of teeth; said outward facing teeth and said inward facing teeth arranged offset either side of a continuous looped groove; said outward facing teeth and said inward facing teeth looping around ends of said looped groove; said looped groove defining a boundary of a spine concentric with the periphery of said rotating output disc; said spine provided with a gap defined by rounded end portions.

Preferably, said output spur gear is maintained in meshing relationship with said continuous toothed path by engagement of said tapered spike with said looped groove.

Preferably, rotation of said rotating output disc changes direction from a first direction to a second opposite direction when said output spur gear passes through said gap; said output spur gear changing from engagement with said outward facing teeth to engagement with said inward facing teeth.

Preferably, each said rotation of said rotating output disc in said first direction and in said second opposite direction is at least a portion of one revolution of said suction hose.

In another broad form of the invention there is provided a method of inducing variable randomized patterns of traversing at least a floor of a swimming pool by a suction cleaning device; said method including the steps of:
(a) a flow driven mechanism adapted to providing substantially continuous rotation to a suction hose of said pool cleaning device,
(b) attaching said suction hose to an angled connector rotationally connected to a swivelling output port of said suction cleaning device.

Preferably, said substantially continuous rotation is uni-directional.

Preferably, said substantially continuous rotation comprises at least a partial revolution in a first direction alternating with at least a partial revolution in a second opposite direction.

### BRIEF DESCRIPTION OF THE DRAWINGS

Embodiments of the present invention will now be described with reference to the accompanying drawings wherein:

FIG. 1 is a perspective view of a portion of a swimming pool, a pool water filtering suction pump and the head of a suction cleaner device connected to the pump by a suction hose, with a rotation apparatus interposed between the hose and the inlet pipe for the pump.

FIG. 2 is a perspective exploded view of the geared, water flow driven rotation mechanism of FIG. 1,

FIG. 3 is a perspective view of an angled connector between an end of the hose and the outlet of the pool cleaner scavenging head of FIG. 1.

FIG. 4 is a perspective view of the head of a suction cleaner device provided with a rotation apparatus,

FIG. 5 is a perspective exploded view of a further embodiment of a geared water flow driven mechanism,

FIG. 6 is a perspective view of the geared water driven mechanism of FIG. 5 when assembled,

FIG. 7 a sectioned side view of a final section of a geared drive train of a further embodiment of a drive mechanism for the provision of alternating rotation of the rotating output disc component and suction hose of FIG. 1,

FIG. 8 is a plan view of the inside surface of an rotating output disc component of the final drive section of FIG. 7 showing a first arrangement of teeth and roller guide surfaces,

FIG. 9 is a sectioned side view of a second arrangement of the final drive section for an alternating rotation of a rotating output disc component,

FIG. 10 is a plan view of the inside surface of a rotating output disc component of the final drive section of FIG. 9 showing a second arrangement of teeth and roller guide surfaces,

FIG. 11 is a sectioned side view of a third arrangement of the final drive section for the alternating rotation of a rotating output disc component,

FIG. 12 is a plan view of the inside surface of the rotating output disc component of the final drive section of FIG. 11 showing an arrangement of teeth and guide slot.

### DETAILED DESCRIPTION OF PREFERRED EMBODIMENTS

### First Preferred Embodiment

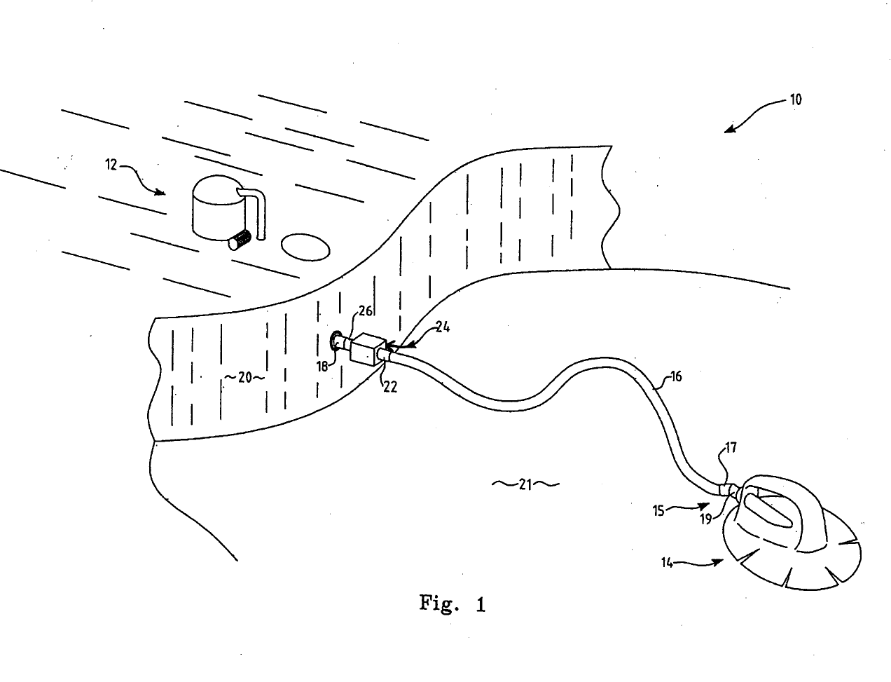

With reference to FIG. 1, a swimming pool 10 is provided with a suction pump 12, drawing water from a suction cleaner device 14 via hose 16. Hose 16 is normally directly connected to a pump inlet pipe 18 at a side wall 20 of swimming pool 10, but in this first preferred embodiment of the invention, hose 16 is connected to an inlet pipe 22 of a geared, water flow driven mechanism 24. Mechanism 24 is in turn, connected by its outlet pipe 26 to inlet pipe 18 of pump 12. The inlet end 15 of suction hose 16 is connected, for example as a press fit, to an angled connector 17, which in turn is attached, again for example as a press fit, to the swivelling outlet port 19 of suction cleaner device 14.

Mechanism 24 provides for rotation of inlet pipe 22 together with hose 16, relative to outlet pipe 26 and outlet port 19 so as to induce axial rotation of hose 16 and of angled connector 17. Preferably, rotation is at a rate of between one and six revolutions per hour. By this means the curl-set of hose 16, together with the angled connector 17, continually redirect the suction cleaner head to all areas of the pool floor 21 and not allow it to become stuck in some corners. The rotation induced by mechanism 20 in effect acts as power steering for the suction cleaner device. Rotating the hose and angled connector alters the geometry of the propulsion force of the pool cleaner thus steering the pool cleaner all over the pool.

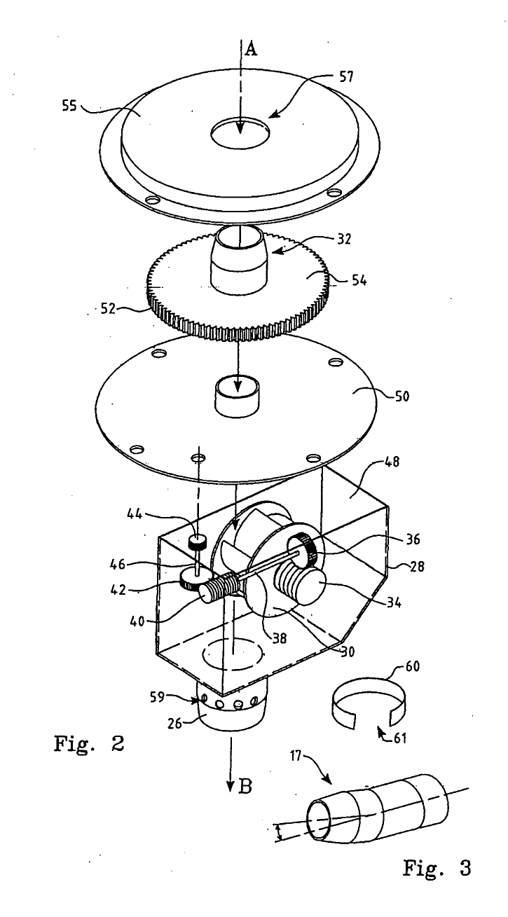

With reference now to FIG. 2, outlet pipe 26 is rigidly connected to a first chamber 28 housing a turbine in the form of a paddle wheel 30. Paddle wheel 30 is forced to rotate by flow of water (as indicated by dashed line A-B) drawn in trough inlet pipe 32 and passing through chamber 28. A first worm gear 34 is mounted to the rotation shaft of paddle wheel 30, and drives first gear wheel 36 mounted on shaft 38. Shaft 38 also carries a second worm gear 40, which in its turn drives second gear wheel 42. Gear wheel 42 drives an output spur gear 44 via shaft 46. Shaft 46 passes through the end 48 of chamber 28 and through cover plate 50 (when cover plate 50 is assembled to chamber 28) to mesh with a ring gear 52 provided at the periphery of rotating output disc 54. Inlet pipe 32 is rigidly mounted to rotating output disc 54, so that when paddle wheel 30 rotates and drives the reduction gear train made up of the worm gears, gear wheels, spur and ring gear, inlet pipe 32 rotates relative to outlet pipe 26.

Preferably, rotating output disc 54 is enclosed by outer cover 55, provided with a central aperture 57 through which inlet pipe 32 projects when the components are assembled together.

Outlet pipe 26 may be provided around a section of its circumference with a number of apertures 59. A slip ring 60, is adapted to partially encircle outlet pipe 26 at the level of apertures 59. Slip ring 60 has a gap 61 which is such as to expose all of apertures 59 when the ring is rotated about inlet pipe 26 to a first appropriate position, or fully cover all of apertures 59 when rotated to a second appropriate position. Thus slip ring 60 may be adjusted to expose none, one or more, or all of apertures 59 to an inflow of water created by suction in outlet pipe 26 by the suction pump 12. This allows an adjustment of the flow of water impacting the paddle wheel 30 and hence the rate of rotation of inlet pipe 32 relative to outlet pipe 26.

Angled connector 17 is arranged such that the axes of its inlet and outlet ends intersect to form a supplementary angle between them of α°. The value of α preferably lies in the range of 15° to 60°.

It will be appreciated that the rotation of the hose tends to distribute wear of the hose due to scuffing on the sides of the pool, rather than having that wear concentrated primarily along sides of the hose. A particular further advantage is that an upper side of the hose is not continually subjected to the effect of ultra-violet radiation.

In at least one form of this embodiment, inlet pipe 32 and outlet pipe 26 are so formed as to allow a tapered push-fit connection between hose 16 and inlet pipe 32, and between pump inlet 18 and outlet pipe 26, so that the mechanism can be readily retrofitted to existing pool cleaning equipment.

### Second Preferred Embodiment

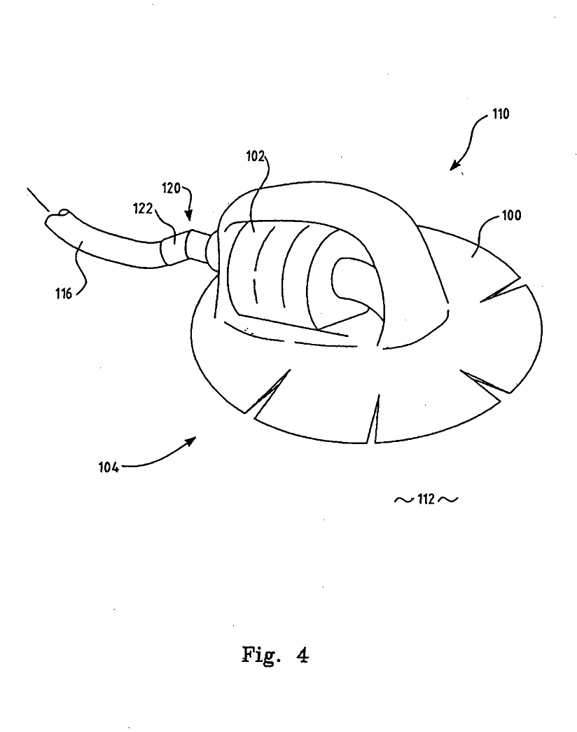

In a second preferred embodiment of the invention with reference to FIG. 4, the head 100 of a suction cleaner device 110 for the floor 112 of a swimming pool incorporates a rotation mechanism 102 comprising a turbine and reduction gear train substantially as described above for the first preferred embodiment.

In this embodiment also, the turbine is activated by flow of water entering the underside 104 of head 100 and passing through hose 116 under the influence of a swimming pool filtration system suction pump (not shown). In this embodiment of the invention the rotating output disc driven by the paddle wheel of the turbine via the reduction gear train, carries the inlet end 118 of an outlet port 120. Outlet port 120 is in the form of the angled connector previously described. Hose 116 is attached via a swivelling connection to the output end 122 of the port 120, and its output end is affixed as a press fit to the inlet pipe (not shown) at the wall of the swimming pool leading to the suction pump.

### Third Preferred Embodiment

In this embodiment also, the rotation mechanism is incorporated in the head of a suction cleaner device 110 as described above for the second preferred embodiment. In this case however, hose 116 is affixed to output end 122 of outlet port 120 so that hose 116 is caused to rotate axially as port 120 is rotated by mechanism 102. The outlet end of hose 116 is, in this embodiment, rotationally connected by means of a swivel to the inlet pipe (not shown) at the wall of the swimming pool leading to the suction pump.

### Fourth Preferred Embodiment

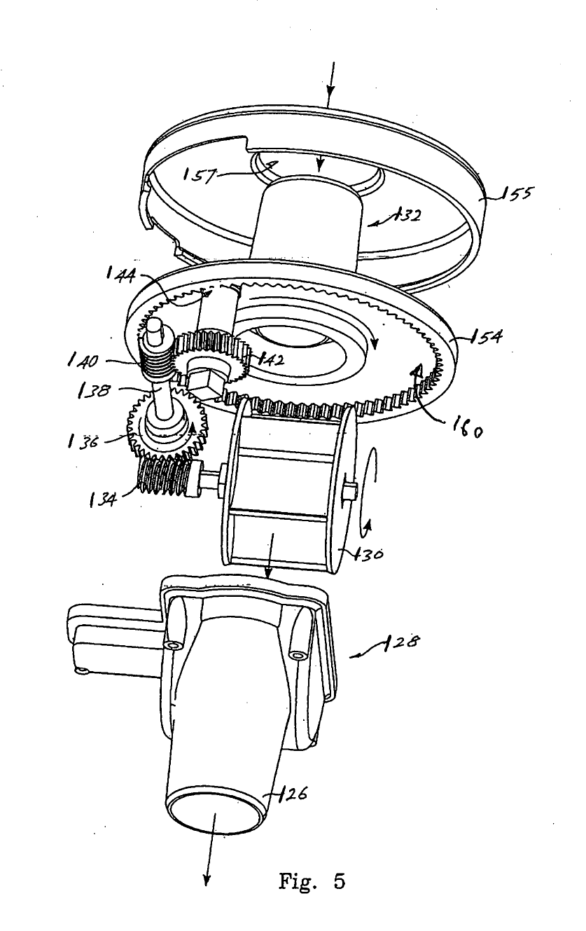

With reference to FIGS. 5 and 6, this embodiment of the invention is a variation on the First Preferred Embodiment described above and like features in FIGS. 5 and 6 are similarly numbered as those of FIG. 2 with the addition of one hundred.

In this embodiment as seen in FIG. 6, the drive mechanism is enclosed by first body section 128, and second body section 129. Cover plate 155 is in this embodiment integral with second body section 131. For clarity, FIG. 5 shows only first body section 128 which is integral with outlet pipe 126.

In this embodiment also a flow of water, induced by a suction pump (not shown), indicated by arrows, passes through inlet pipe 132 to impact and urge rotation of paddle wheel 130. Rotation of paddle wheel 130 in like manner to that of the First Preferred Embodiment, sets in motion a reduction gear train made up of first worm gear 134, first gear wheel 136, second worm gear 140, second gear wheel 142 to finally urge rotating output disc 154 into rotation. However in this embodiment the teeth of rotating output disc 154 are set internally in a recess 160 of disc 154.

Again it will be understood, that by attaching outlet pipe to the inlet opening of a pool filtration system at the side wall of a swimming pool, and attaching a pool cleaner suction hose to inlet pipe 132, the hose will be urged into rotation.

### Fifth Preferred Embodiment

In this further embodiment, the arrangement of suction pump inlet pipe 18, connecting hose 16 and suction cleaning head 14 remain as described for the First Embodiment above and as shown in FIG. 1, again with an angled connector 17 located at the swivelling outlet port 19 of a suction cleaner device 14. In this embodiment also, a water flow driven mechanism 24 is interposed between the pump inlet pipe 18 at the side wall 20 of the pool 10, again as shown in FIG. 1.

Mechanism 24 in this embodiment of the invention however, is provided with a reduction gear train adapted to urge a reciprocating rotation in connecting hose 16, providing for approximately one revolution in a clockwise direction followed immediately by approximately one counter-clockwise revolution. As for previous embodiments and with reference to FIG. 1, mechanism 24 includes a turbine paddle wheel 30 driven into uni-directional rotation by a flow of water passing through connecting hose 16, through the housing 28 of mechanism 24 to suction pump inlet pipe 18. Rotation of paddle wheel 30 is communicated via first worm gear 34 to first gear wheel 36 which is connected by shaft 38 to second worm gear 40.

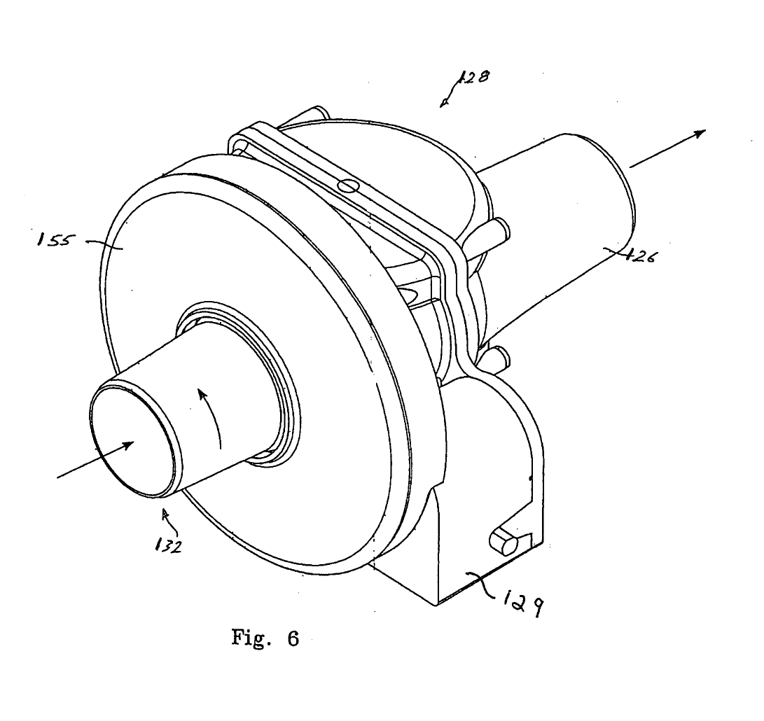

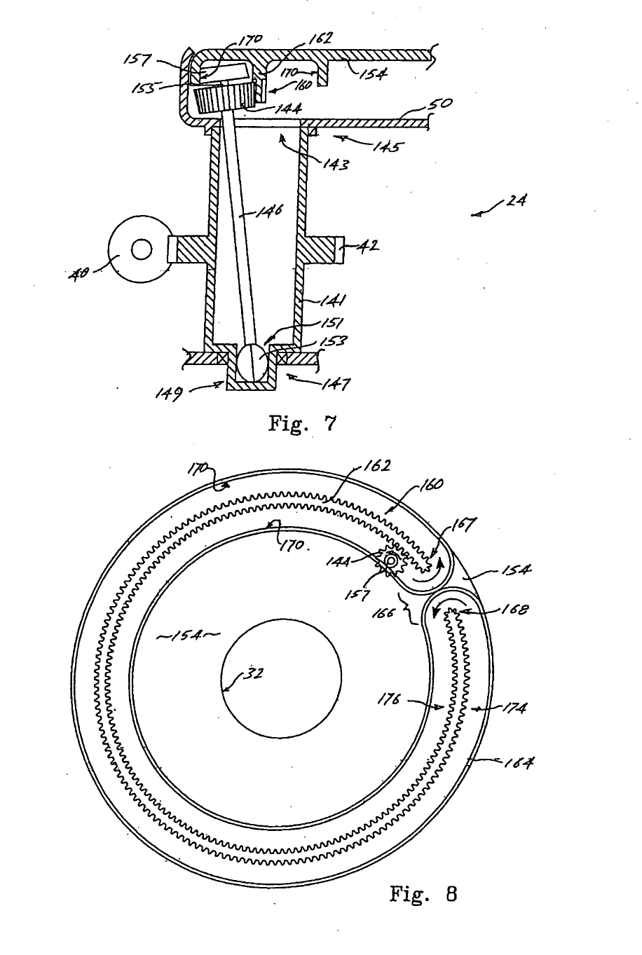

FIG. 7 shows the final stages of the reduction gear train of this embodiment. Second worm gear 40 drives second gear wheel 42. In this embodiment with reference now to FIG. 8, second gear wheel 42 is rigidly mounted to, or forms an integral part of, a tubular member 141 acting as the rotation shaft of second gear wheel 42. Tubular member 141 is mounted at a first open end 143 in an upper bearing 145 in backing plate 50 and in a lower bearing 147 at an opposite second closed end 149.

Closed end 149 forms a socket 151 adapted to accept the ball-drive end 153 of a shaft 146 located within tubular member 141. Ball-drive end 153 is provided with facets which engage with matching flat surfaces in socket 151 (for example in the manner of a ball-ended hexagon drive of an Allen Key). The arrangement is such that shaft 146 can assume any angled disposition within tubular member 141 to the extent allowed by the respective tube and shaft diameters and lengths.

Shaft 146 is provided proximate its opposite outer end with output spur gear 144. Shaft 146 extends through output spur gear 144 to provide an axle portion 155 to which is mounted a free rotating roller 157 having a diameter smaller than the root diameter of the output spur gear 144. As in previously described embodiments, this output spur gear 144, (the equivalent of output spur gear 44 described above), drives the rotation of rotating output disc 154, and hence the rotation of the suction hose 16 attached to inlet pipe 32 shown in FIG. 1.

With further reference to FIG. 7 a variation is contemplated where there is no projection of the shaft 146 beyond the spur gear 144. Instead, in this variation, there is provided a spine and inward/outward facing teeth in one as shown in FIG. 7. The spur gear is then supported within a channel by extending the inner edge upwards, so that it has constant meshing with the ring gear.

Rotating output disc 154 is provided with either one of a particular arrangement of teeth and roller element guide surface as best seen in FIGS. 8 and 10.

In a first form of this arrangement shown in FIG. 8, a continuous loop of inward and outward facing teeth 160 is arranged along the inside and outside a spine 162 concentric with the periphery 164 of rotating output disc 154. Spine 162 has a gap 166 at one point, with teeth 160 continuing around the terminal ends 167 and 168 of the gap 166 to form a continuous path of teeth. Concentric with, and enclosing spine 162 and teeth 160 is a continuous guide rail or surface 170 offset from the teeth 160 sufficient to maintain meshing contact between output spur gear 144 and teeth 160 (as best seen in FIG. 8) through the rolling contact between surface 170 and roller 157. Guide surface 170 loops around each terminal end 167 and 168 at gap 166.

As second gear wheel 42 is urged to rotate by second worm gear 40, tubular member 141 rotates within its bearings 145 and 147. Shaft 146 rotates in unison with tubular member 141 to which it is pivotally engaged at ball-shaped end 153. Rotation of output spur gear 144 then drives the rotation of rotating output disc 154. In the arrangement of FIG. 8 an anti-clockwise rotation of output spur gear 144 causes a clockwise rotation of rotating output disc 154 while output spur gear 144 is meshed with teeth 160 at the outward side 174 of spine 162. When rotation of rotating output disc brings 154 brings gap 166 to output spur gear 144, there is a brief pause in rotation of disc 154 as output spur gear 144 passes around the teeth at a terminal end of the spine 162, but then follows a reversal of the direction of rotation of the disc 154 as output spur gear 144 drives against the teeth at the inward side 176. Direction of rotation is reversed again as rotation brings the gap 166 again to output spur gear 144, with the output spur gear passing again through the gap around the other terminal end of the spine 162 to mesh with, and drive against the teeth at the outward side 174 of spine 162.

It will be appreciated that the movement of the output spur gear 144 through the gap 166, and its changing from meshing with teeth at outward side 174 to meshing with teeth at the inward side 176 causes a change in the angle of shaft 146 as it describes a conical path at the open end of tubular member 141. This angular movement is provided for by the engagement between the ball-shaped end 153 of shaft 146 and the socket 151 of tubular member 141. It will also be appreciated that shaft 146 is continually disposed at an angle to the plane defined by rotating output disc 154, and thus to teeth 160. Preferably therefore, output spur gear 144 is a bevelled gear with teeth set at the appropriate angle determined by the diameter of output spur gear 144, the width of spine 162 and the length of shaft 146.

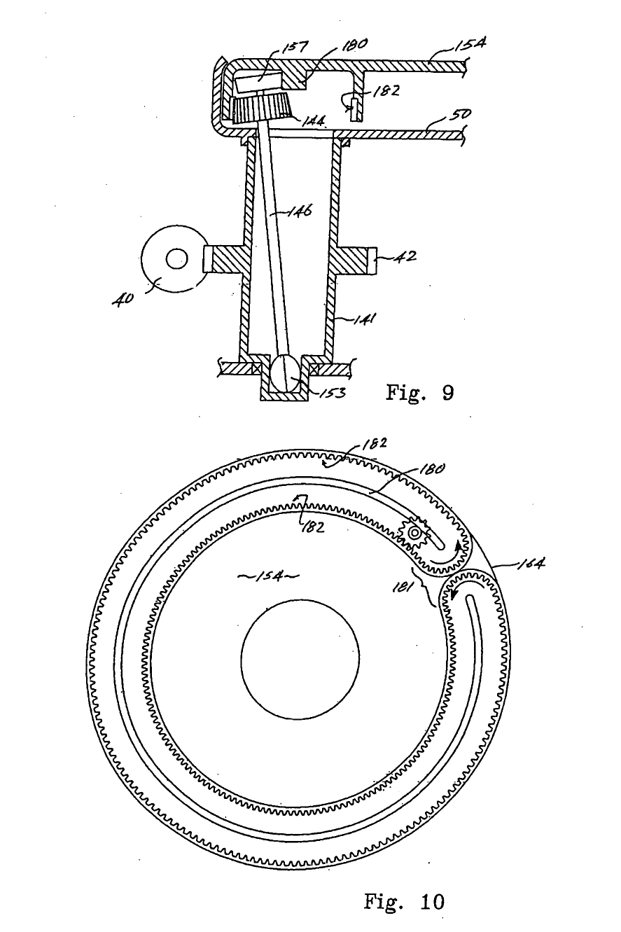

In a second form of an arrangement of the teeth and guide surface for a roller element provided in rotating output disc 154 shown in FIGS. 9 and 10, the teeth and guide rail are effectively interchanged. Rotating output disc 154 is again provided with a spine 180 concentric with the outer edge 164 of the disc and having a gap 181, but in this arrangement the spine 180 is smooth and its sides act as a guide surface for roller 157 constraining output spur gear 144 to mesh with teeth 182, now arranged in the pattern of the previously described guide surface.

The effect of this arrangement is the same as for the first form above, in that there is a change of direction of rotation of the rotating output disc 154 every time output spur gear 144 reaches gap 181 and passes through it to mesh with the opposite line of teeth.

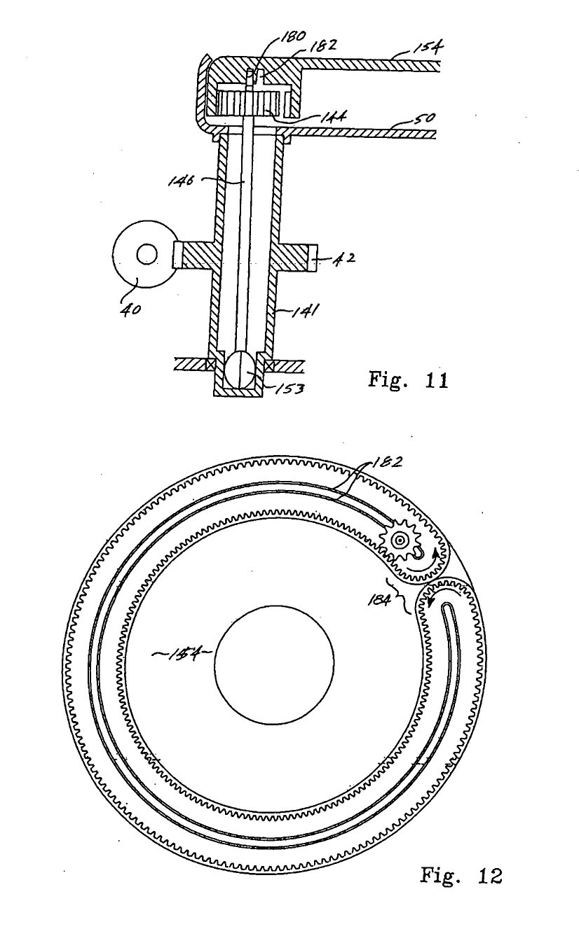

While guidance of output spur gear 144 is preferably provided by the free rotating roller 157, in an alternative arrangement shown in FIGS. 11 and 12, guidance may be provided by a simple tapering extension forming pin 180 of shaft 146 projecting beyond output spur gear 144, and sliding in a continuous looping groove 182 as shown in FIG. 12. Looping groove 182 is of similar configuration to the spine 180 described above, in effect defining a boundary of the spine. The looping groove is also arranged to have a gap 184 defined by rounded end portions. A continuous path of outward facing teeth and inward facing teeth is offset from the looping groove 182.

It will be noted that in the flow driven mechanisms utilized in each of the above embodiments, the rotation of the drive train and final drive transmitting rotation to the suction hose and angled connector is continuous. Although there is a slight pause in rotation in the case of the Fifth Embodiment as the output spur gear moves between the outward facing teeth and the inward facing teeth at each reversal of direction of rotation, rotation of the suction hose and angled connector remains substantially continuous.

### In Use

In use, each of the arrangements of the Fifth Preferred Embodiment, provide rotation to the suction hose 16 which, in combination with the angled connector 17 at the outlet of the suction cleaner device, provides the steering properties which induce a randomized pattern of traversing the floor and other surfaces of a swimming pool. As well, rotation of the suction hose reduces the uneven exposure to ultraviolet radiation of a non-rotating hose, while the alternating rotation of the Fifth Embodiment assists in preventing the suction cleaner device from “hanging up” in corners or at steps for example.

The above describes only some embodiments of the present invention and modifications, obvious to those skilled in the art, can be made thereto without departing from the scope and spirit of the present invention.

1. An apparatus for inducing variable randomized patterns of traversing at least a floor of a swimming pool by a suction cleaner device; said apparatus including a water flow driven mechanism interposed between a suction pump inlet in a wall of said swimming pool and said suction cleaning device; said apparatus further including a suction hose and an angled connector attached to said suction hose; said angled connector rotatably connected to a swivelling outlet port of said suction cleaning device; said apparatus inducing substantially continuous axial rotation of said suction hose and said angled connector whereby rotating the hose and angled connector alters the geometry of the propulsion force of the pool cleaner thus steering the pool cleaner all over the pool.

2. The apparatus of claim 1 wherein said axial rotation is continuous and uni-directional.

3. The apparatus of claim 1 wherein said axial rotation is alternating; said rotation comprising at least a portion of a revolution in a first direction followed by at least a portion of a revolution in a second opposite direction.

4. The apparatus of claim 1, wherein said angled connector is arranged such that the axis of an inlet end of said connector and the axis of an outlet end of said connector intersect to form a supplementary angle between said inlet axis and said outlet axis; said supplementary angle having a value in the range of 15° to 60°.

5. The apparatus of claim 1, wherein said water flow driven mechanism is installed coaxially between an outlet end of said suction hose and said suction pump inlet; said mechanism provided with an inlet pipe connected to said outlet end of said hose; said mechanism further provided with an outlet pipe connected to said suction pump inlet.

6. The apparatus of claim 5 wherein said outlet pipe is connected to a non-rotating first chamber of said mechanism; and wherein a rotating output disc is mounted to said non-rotating first chamber; said non-rotating first chamber housing a turbine paddle wheel rotationally reactive to said water flow.

7. The apparatus of claim 6 wherein an output shaft of said turbine paddle wheel is connected to a reduction gear train; said reduction gear train adapted to rotate said inlet pipe of said water flow driven mechanism.

8. The apparatus of claim 7 wherein said inlet pipe is concentrically mounted to a rotating output disc; said rotating output disc provided with an arrangement of gear teeth meshing with an output spur gear of said reduction gear train.

9. The apparatus of claim 8 wherein said arrangement of gear teeth comprises a ring gear incorporated in said rotating output disc; said ring gear concentric with said disc and said inlet pipe.

10. The apparatus of claim 9 wherein said ring gear is an external ring gear around the periphery of said rotating output disc.

11. The apparatus of claim 9 wherein said ring gear is an internal ring gear proximate said periphery of said rotating output disc.

12. The apparatus of any one of claim 8, wherein a shaft of said output spur gear is retained within a tubular member; said output spur gear shaft provided with a ball-drive end at an end of said shaft distal from said output spur gear; said ball-drive end provided with facets adapted to engage with surfaces within a socket end of said tubular member; said tubular member rotationally mounted between an upper bearing and a lower bearing.

13. The apparatus of claim 12 wherein said tubular member acts as a shaft of a gear wheel; said reduction gear train acting on said gear wheel to rotate said tubular member; rotation of said tubular member transferred to said output spur gear shaft through said socket and said ball-drive end.

14. The apparatus of claim 8, wherein said output spur gear is provided with a projecting axle portion; said axle portion supporting a free rotating roller mounted adjacent to and coaxial with said output spur gear.

15. The apparatus of claim 8, wherein said output spur gear is provided with a projecting tapered spike; said spike coaxial with said output spur gear.

16. The apparatus of claim 8, wherein said arrangement of gear teeth comprises a looped combination of outward facing teeth and inward facing teeth; said teeth arranged along outside and inside facing surfaces of a spine concentric with the periphery of said rotating output disc; said spine having a gap defined by first and second ends of said spine; said outward facing teeth and said inward facing teeth looping around said first and second ends to form a continuous toothed path.

17. The apparatus of claim 8, wherein said arrangement of gear teeth comprises a looped combination of outward facing teeth and inward facing teeth; said teeth offset from a spine concentric with the periphery of said rotating output disc; said spine having a gap defined by first and second ends of said spine; said outward facing teeth and said inward facing teeth looping around said ends to form a continuous toothed path.

18. The apparatus of claim 16, wherein a continuous guide surface is offset from said continuous toothed path; said continuous guide surface comprising outward facing and inward facing guide surfaces looping around said first and second ends to form said continuous guide surface, and wherein said output spur gear is maintained in meshing relationship with said continuous toothed path by contact of said roller with said continuous guide surface.

19. The apparatus of claim 15 wherein said arrangement of gear teeth comprises a looped combination of outward facing teeth and inward facing teeth forming a continuous looped path of teeth; said outward facing teeth and said inward facing teeth arranged offset either side of a continuous looped groove; said outward facing teeth and said inward facing teeth looping around ends of said looped groove; said looped groove defining a boundary of a spine concentric with the periphery of said rotating output disc; said spine provided with a gap defined by rounded end portions.

20. The apparatus of claim 19 wherein said output spur gear is maintained in meshing relationship with said continuous toothed path by engagement of said tapered spike with said looped groove.

21. The apparatus of claim 16, wherein rotation of said rotating output disc changes direction from a first direction to a second opposite direction when said output spur gear passes through said gap; said output spur gear changing from engagement with said outward facing teeth to engagement with said inward facing teeth.

22. The apparatus of claim 21 wherein each said rotation of said rotating output disc in said first direction and in said second opposite direction is at least a portion of one revolution of said suction hose.

23. A method of inducing variable randomized patterns of traversing at least a floor of a swimming pool by a suction cleaning device; said method including the steps of:
(a) a flow driven mechanism adapted to providing substantially continuous rotation to a suction hose of said pool cleaning device,
(b) attaching said suction hose to an angled connector rotationally connected to a swivelling output port of said suction cleaning device.

24. The method of claim 23 wherein said substantially continuous rotation is uni-directional.

25. The method of claim 23 wherein said substantially continuous rotation comprises at least a partial revolution in a first direction alternating with at least a partial revolution in a second opposite direction.
